(19) United States
(12) Patent Application Publication
(10) Pub. No.: US 2007/0224944 A1
(43) Pub. Date: Sep. 27, 2007

(54) Portable device having changeable operating modes

(76) Inventor: Hsiang Chen, Taipei (TW)

Correspondence Address: RABIN & Berdo, PC, 1101 14TH STREET, NW, SUITE 500, WASHINGTON, DC, 20005, US

(21) Appl. No.: 11/372,134

(22) Filed: Mar. 10, 2006

(51) Int. Cl. H04B 1/38; H04M 1/00

(52) U.S. Cl. 455/90.3; 455/566

(57) ABSTRACT

A portable device having changeable operating modes is provided, which comprises a host housing, a display unit, a control unit, a first operating unit and a second operating unit. The portable device changes the screen display mode and operating mode thereof by using the slip position of a display screen so as to present different operating states, such that a user will not be limited to a fixed state of the operating unit in the portable device, and in different operating modes, the portable device will turn to the corresponding display modes and operating states.

### BACKGROUND OF THE INVENTION

1. Field of Invention

The present invention relates to a portable device, more particularly to a portable device having changeable operating modes, which changes its screen display mode and operating mode by using the slip position of a display screen so as to present different operating states.

2. Related Art

In the general trend of 3C integration, the convenience of a mobile phone has mingled in every walk of life of the society and people's life. A mobile phone has two essential characteristics of individual privacy and portability. The cell phone has evolved from having a simple call function into having the integrated functions of communication, calculation, electronic consumption, and commodity, etc., therefore, the mobile phone is no longer just being a communication tool, but has yet become a kind of private portable product, which is used for communicating feelings, facilitating travel and work, and convenient entertainment.

With the mobile phone coming into being a popular commodity, the differences in users' demands have enhanced. The mobile phone provides various functions such as camera shooting, MP3, games, karaoke, personal data management, color screen, Multimedia Message Service (MMS) with instant shooting, viewing and sending functions, and the like. In addition, with the development of the cell phone having a color screen and the function of accessing the Internet, JAVA games having the functions of audio effect, vibration, and flash, accompanying with the color screen of big size, the lifelike effect of online games in the mobile phone has been no longer inferior to that of the Gameboy handheld game machine of Nintendo. And since the f mobile phone can access to the Internet without limited by a transmit distance, the playing of online games with the mobile phone is not limited by space conditions, therefore, games also become the common language and topic among people, such that the interaction among people becomes more frequent.

However, the general mobile phone typically has a fixed operating unit, for example, the up, down, left, and right of game software are represented by numerical keys, as a result, it is very inconvenient for a user to operate the fixed operating unit of the mobile phone with two hands when playing games with the mobile phone.

### SUMMARY OF THE INVENTION

In view of the above problem, the primary object of the invention is to provide a portable device having changeable operating modes, thereby solving the problem existed in the related art.

In order to achieve the above object, the portable device having changeable operating modes disclosed in the invention includes a host housing, a pivot, a display unit, a control unit, a first operating unit, and a second operating unit. The host housing has a panel and a back face of the host housing, and the first operating unit covers on the panel of the host housing. The pivot connects the host housing with the panel, such that the host housing and the panel can present a lid-lifted state and a closed state. The display unit has a display face, an accommodation space and a bonded face. A slip fit between the bonded face and the back face of the host housing is formed when the portable device is in the lid-lifted state, and a control signal is output of the relative position to the control unit by using the relative slippage between the bonded face and the back face of the host housing, so as to switch among a screen display mode, an operating mode, and a signal transmission of the portable device. The second operating unit is disposed within the accommodation space and positioned below the display unit.

The portable device having the changeable operating mode disclosed according to the invention causes its screen display mode and operating mode to present different operating states by using the slip position of the display screen, such that a user may set different operating states according to his own taste without being limited to the fixed state of operating unit in the mobile phone when performing any functions.

The detailed characteristics and advantages of the invention will be described in detail in the detailed description below, whose context is sufficient for any skilled in the art to understand the technical context of the invention and to perform it. And any skilled in the art may easily understand the related objects and advantages of the invention according to the content disclosed in the specification, claims, and drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of one embodiment according to the invention;

FIG. 2 is a wire diagram of the display unit for the portable device disclosed according to the invention;

FIG. 3 is an operation diagram of the portable device disclosed according to the invention; and

FIG. 4 is another embodied aspect of the portable device disclosed according to the invention.

### DETAILED DESCRIPTION OF THE INVENTION

The portable device having changeable operating modes disclosed according to the invention causes the operating mode of the portable device to present different screen display modes and operating states by using the slip position of the display screen. The portable device may be a mobile phone, Personal Digital Aid (PDA), a handheld computer or other portable electronic devices.

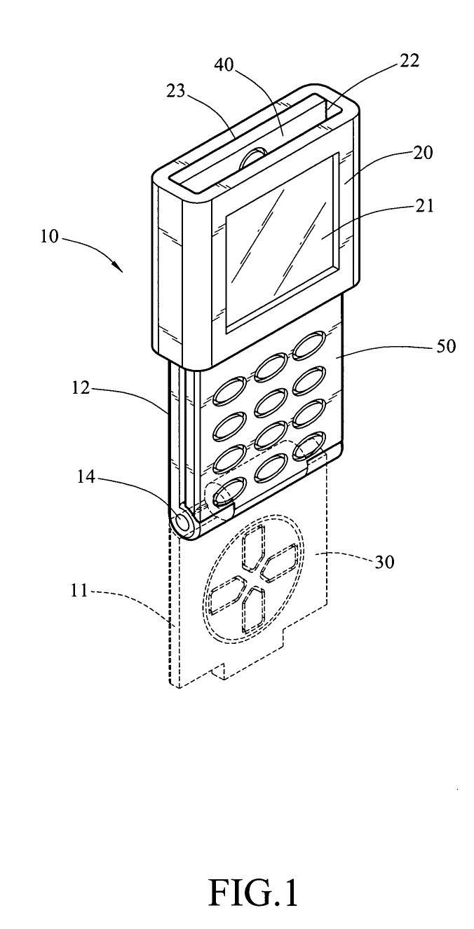

Referring to FIG. 1, which is a schematic view of one embodiment according to the invention, this embodiment is illustrated by taking the mobile phone as an example. This mobile phone includes a host housing 10, a display unit 20, a control unit (not shown), a first operating unit 30, a second operating unit 40, and a third operating unit 50. The host housing 10 has a panel 11 and a back face 12 of the host housing 10, while the first operating unit 30 and the third operating unit 50 respectively cover on the panel 11. The aspect ratio of both the first operating unit 30 and the third operating unit 50 is appropriate to fully cover on the panel 11. Additionally, a pivot 14 is disposed between the host housing 10 and the panel 11, which causes the host housing 10 and the panel 11 to present a lid-lifted state (which means the host housing 10 and the panel 11 present a predetermined angle) and a closed state (which means the host housing 10 is parallel to the panel 11 or the host housing 10 and the panel 11 present an angle of 180 degrees).

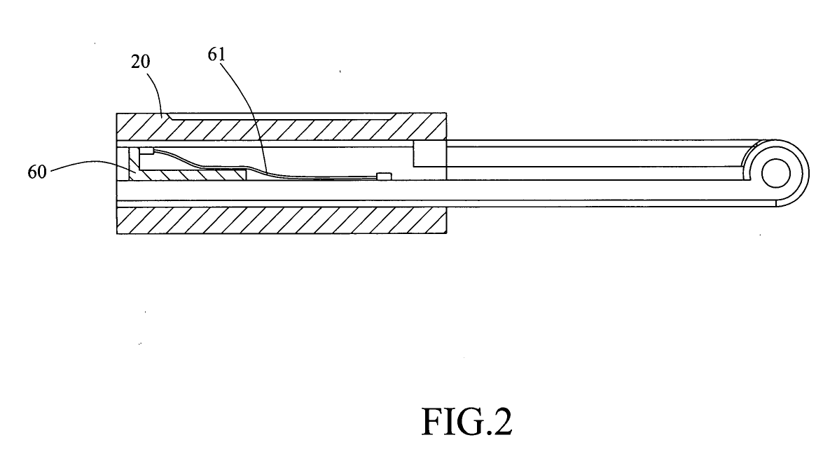

The display unit 20 has a display face 21, an accommodation space 22 and a bonded face 23, wherein a slip fit between the bonded face 23 of the display unit 20 and the back face 12 of the host housing 10 is formed through a guide track when the mobile phone is in the lid-lifted state, and the second operating unit 40 is fully exposed by the relative slip between them. And a control signal of the relative position is output so as to switch the mobile phone to the communication mode or game mode. The display unit 20 can normally operate through a guide panel 60 and at least one guide line 61, as shown in FIG. 2. The guide panel 60 connected to the back face 12 of the display face 21 in the display unit 20 is L-shaped, while the guide line 61 is electrically connected to either surface of the control unit and the back face 12 of the display unit 20 along the L shape of the guide panel 11, such that with the signal transmission of the guide line 61, the display unit 20 may operate normally.

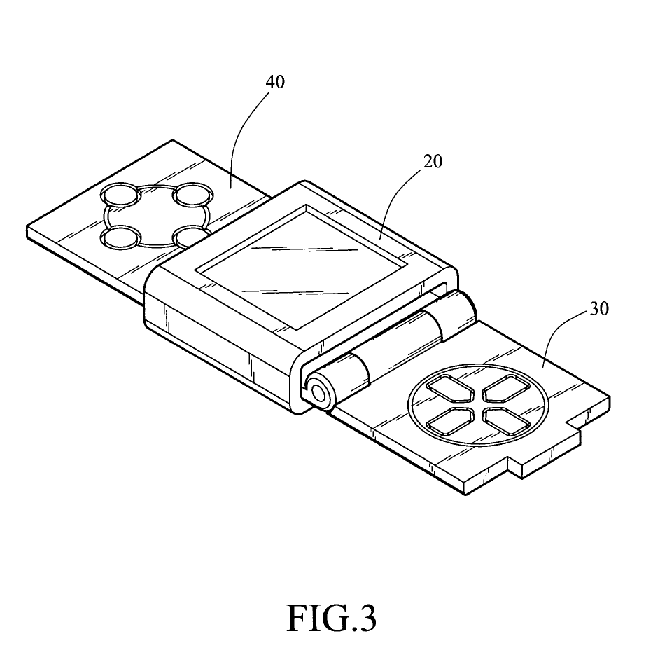

The control unit responds to the control signal transmitted by the display unit 20, switches the display mode and operating mode of the mobile phone and performs a signal transmission. The display mode of the mobile phone comprises a vertical display mode and a horizontal display mode, while the operating mode comprises a communication mode and a game mode. When the mobile phone is switched to the communication mode at which time the display unit 20 is positioned in the first guide track position, it may perform the communication function by means of the first operating unit 30 and the third operating unit 50, while the second operating unit 40 is disposed within the accommodation space 22, not exposed, as shown in FIG. 1. When the mobile phone is switched to the game mode at which time the display unit 20 is positioned in the second guide track position, the second operating unit 40 is exposed such that the mobile phone may perform the game mode by means of the second operating unit 40 and the third operating unit 50, as shown in FIG. 3.

Additionally, a lid-lifting button is disposed on the host housing 10 of this mobile phone, such that the mobile phone may present the lid-lifted state in a manual way (that is by pressing the lid-lifting button), and the mobile phone may present the lid-lifted state by moving the display unit 20 upward or downward a short distance.

Each of the above operating units is disposed on the host housing 10, which may be any one of four directional keys, four directional rockers, four directional trackballs, a digital board, a plurality of keys and a touch panel 11. If there are keys in each operating unit, each of the keys may be a combined group of numbers, characters, and graphics. The first operating unit 30 and the third operating unit 50 cover on the panel 11, while the second operating unit 40 may be exposed or disposed within the accommodation space 22 with a change in the slip position of the display unit 20.

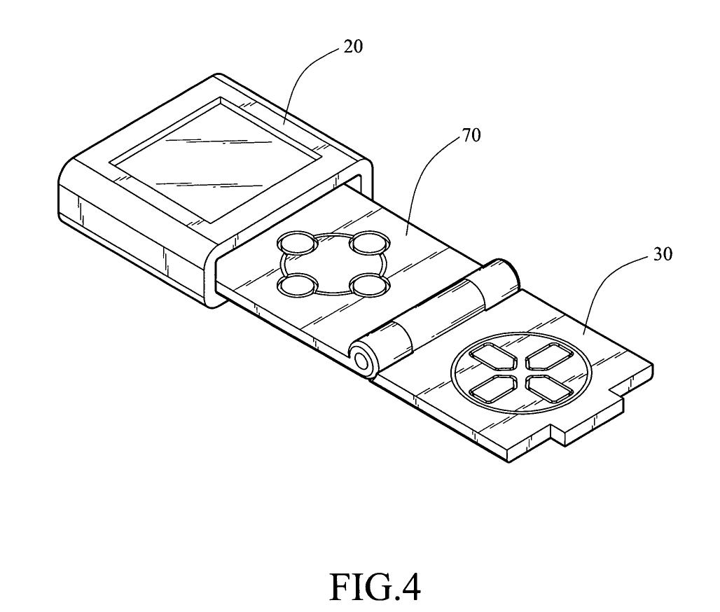

In practical case of using, the space of the host housing 10 allows a fourth operating unit 70 to be further disposed therein, as shown in FIG. 4, so as to perform more operating modes. The host housing 10 needs to include another accommodation space when the fourth operating unit is disposed therein.

Since the general mobile phone typically has the fixed operating unit, it is very inconvenient for a user to operate the fixed operating unit of the mobile phone with two hands. The portable device having the changeable operating mode disclosed according to the invention causes its screen display mode and operating mode to present different operating states by using the slip position of the display screen, such that a user may set different operating states according to his own taste when performing any functions. Therefore, a user will no longer be limited to the fixed operating unit state of the mobile phone.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable device having changeable operating modes, comprising:
a host housing having a panel and a back face;
a pivot for connecting the host housing with the panel such that both the host housing and the panel present a lid-lifted state and a closed state;
a display unit having a display face, an accommodation space, and a bonded face, wherein a slip fit between the bonded face and the back of the host housing is formed when the portable device is in the lid-lifted state, and a control signal of the relative position is output by the relative slippage of the bonded face and the back of the host housing;
a control unit for switching among a screen display mode, an operating mode, and a signal transmission of the portable device in response to the control signal;
a first operating unit disposed on the host housing and covering the bottom face of the panel; and
a second operating unit disposed within the communication space and positioned below the display unit.

2. The portable device having changeable operating modes as claimed in claim 1, further comprising a third operating unit disposed on the host housing and covering above the panel.

3. The portable device having changeable operating modes as claimed in claim 1, wherein the screen display mode comprises a vertical display mode and a horizontal display mode.

4. The portable device having changeable operating modes as claimed in claim 1, wherein the operating mode comprises a communication mode and a game mode.

5. The portable device having changeable operating modes as claimed in claim 1, wherein a guide track is provided on the back face of the host housing.

6. The portable device having changeable operating modes as claimed in claim 1, wherein the display unit comprises:
a guide panel connected to a back face of the display face; and
at least one guide line electrically connected to either surface of the control unit and the back face of the display face along the guide panel such that the display unit operates normally through the guide line.

7. The portable device having changeable operating modes as claimed in claim 1, wherein the guide panel is L-shaped.
